(19) United States
(12) Patent Application Publication
(10) Pub. No.: US 2014/0379423 A1
(43) Pub. Date: Dec. 25, 2014

(54) Market Price based Raw Material Procurement

(71) Applicant: Johann Kemmer, Muehlhausen (DE)

(72) Inventor: Johann Kemmer, Muehlhausen (DE)

(73) Assignee: SAP AG, Walldorf (DE)

(21) Appl. No.: 13/926,955

(22) Filed: Jun. 25, 2013

(51) Int. Cl. G06Q 30/02; G06Q 30/06

(52) U.S. Cl. CPC G06Q 30/0206; G06Q 30/0633
USPC 705/7.31

(57) ABSTRACT

In one embodiment, a method determines pricing information for a raw material used in industrial production of a product for a company. The pricing information includes forecasted pricing information for the raw material. Also, the method determines demand and supply information describing a supply of the raw material for the company and a demand for the raw material of how much of the raw material the company plans to use. Then, the forecasted pricing information and the supply of the raw material and the demand for the raw material are analyzed to determine a point in time in which to order the raw material and an amount of the raw material to order at the point in time. The method automatically generates information for a purchase order for the raw material for the point in time in the amount and outputs the information for the purchase order.

### BACKGROUND

Companies use high-value raw materials in the industrial production of many high-tech products. For example, mobile devices, magnets, touch screens, and solar panels are manufactured using high-value raw materials. In some cases, the availability and cost of high-value raw materials may fluctuate greatly. As high-value raw material costs are some of the biggest costs in the industrial production of the devices, if the high-value raw materials are bought at the wrong time, the cost of the products are adversely affected. Also, if a company waits to buy the high-value raw materials at a possible better price, the company risks depleting available stocks of the high-value raw materials.

### SUMMARY

In one embodiment, a method determines pricing information for a raw material used in industrial production of a product for a company. The pricing information includes forecasted pricing information for the raw material. Also, the method determines demand and supply information describing a supply of the raw material for the company and a demand for the raw material of how much of the raw material the company plans to use. Then, the forecasted pricing information and the supply of the raw material and the demand for the raw material are analyzed to determine a point in time in which to order the raw material and an amount of the raw material to order at the point in time. The method automatically generates information for a purchase order for the raw material for the point in time in the amount and outputs the information for the purchase order.

In one embodiment, a non-transitory computer-readable storage medium contains instructions, that when executed, control a computer system to be configured for: determining pricing information for a raw material used in industrial production of a product for a company, the pricing information including forecasted pricing information for the raw material; determining demand and supply information describing a supply of the raw material for the company and a demand for the raw material of how much of the raw material the company plans to use; analyzing the forecasted pricing information and the supply of the raw material and the demand for the raw material to determine a point in time in which to order the raw material and an amount of the raw material to order at the point in time; automatically generating information for a purchase order for the raw material for the point in time; and outputting the information for the purchase order.

In one embodiment, an apparatus includes: one or more computer processors; and a non-transitory computer-readable storage medium comprising instructions, that when executed, control the one or more computer processors to be configured for: determining pricing information for a raw material used in industrial production of a product for a company, the pricing information including forecasted pricing information for the raw material; determining demand and supply information describing a supply of the raw material for the company and a demand for the raw material of how much of the raw material the company plans to use; analyzing the forecasted pricing information and the supply of the raw material and the demand for the raw material to determine a point in time in which to order the raw material and an amount of the raw material to order at the point in time; automatically generating information for a purchase order for the raw material for the point in time; and outputting the information for the purchase order.

The following detailed description and accompanying drawings provide a better understanding of the nature and advantages of particular embodiments.

### BRIEF DESCRIPTION OF THE DRAWINGS

FIG. 1 depicts a system for generating purchase orders for raw material procurement according to one embodiment.

FIG. 2A depicts a more detailed example of a price forecast engine according to one embodiment.

FIG. 2B shows a graph of an example of a price forecast output by a price analysis manager according to one embodiment.

FIG. 3A depicts a more detailed example of a supply/demand manager according to one embodiment.

FIG. 3B depicts a graph showing an example of supply/demand information according to one embodiment.

FIG. 4 depicts a more detailed example of a procurement calculation engine according to one embodiment.

FIGS. 5A-5C show examples of purchase order decisions according to one embodiment.

FIG. 6 depicts an example for adjusting the price forecast based on the storage costs and financial costs according to one embodiment.

FIG. 7A depicts an example of a schedule according to one embodiment.

FIG. 7B shows a timeline that shows when a procurement manager generates purchase orders according to one embodiment.

FIG. 8 depicts an example of a table that summarizes data that can be customized by a user of the company for the procurement calculation engine according to one embodiment.

FIG. 9 depicts a simplified flowchart of a method for generating purchase orders according to one embodiment.

FIG. 10 illustrates hardware of a special purpose computing machine configured with procurement calculation engine according to one embodiment.

### DETAILED DESCRIPTION

Described herein are techniques for a raw material procurement system. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

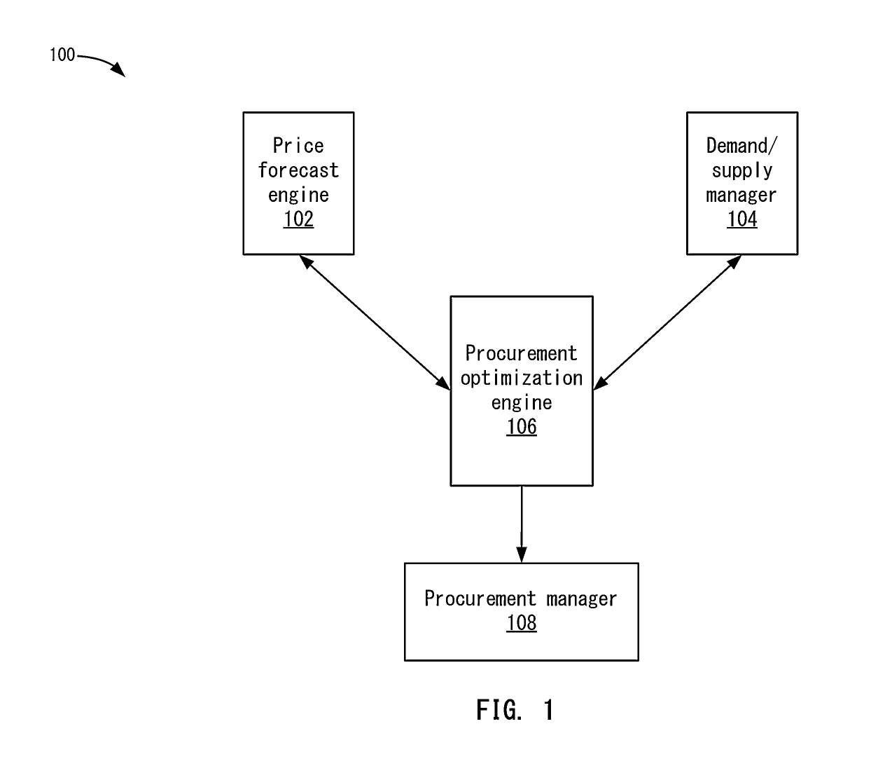

FIG. 1 depicts a system 100 for generating purchase orders for raw material procurement according to one embodiment. System 100 may generate purchase orders (POs) for raw materials that are used in industrial production. These raw materials may be “high-value” raw materials. High-value raw materials may be subject to a higher risk of supply interruption from other raw materials. For example, the risk of supply interruption may be quantified by risk where a raw material with an associated risk of supply interruption above a threshold classifies the raw material as high-value. High-value raw materials are those materials used in industrial production, which are extremely costly and even if only used in very small quantities, the raw materials influence the price of the produced product significantly. The raw materials are traded globally. Trades are based on global market-prices and the raw material future expectations (like foreseen shortages). Examples of high-value raw materials include rare earth metals, such as neodym, europium, erbium, iridium, and germanium. These rare earth metals are used in the metal working industry to produce products such as high-performance magnets, music players, smartphones, touch screens, solar panels, and other high-tech devices. Also, other metals used in industrial production, such as in automotive production, may also be considered high-value raw materials, and include silver, tin, nickel, platinum, palladium, copper, lead, aluminum, and zinc.

System 100 includes a price forecast engine 102 and a supply/demand manager 104. Price forecast engine 102 outputs pricing information regarding the raw materials to a procurement calculation engine 106. In one embodiment, price forecast engine 102 may be an external service or tool outside of an enterprise resource planning (ERP) system that a company uses to plan and organize resource procurement. In other cases, price forecast engine 102 may be integrated with the ERP system. Also, supply/demand manager 104 outputs supply/demand information for the raw material to procurement calculation engine 106. In one embodiment, supply/demand manager 104 may be part of the company's ERP system. The pricing information and supply/demand information will be described in more detail below.

Procurement optimization engine 106 uses the pricing information and supply/demand information to generate a schedule that indicates times to procure the raw materials and also quantities of the raw materials to order on each of the times. For example, the schedule may list various dates and quantities to purchase the raw materials on those respective dates. A procurement manager 108 of the ERP system receives the schedule and automatically generates purchase orders for the specific quantities of raw materials on the specified dates or outputs purchase order requests for further optimization like (automated) bundling. When purchase order requests are used, the requests may encompass both purchase order generation and a request for a purchase order. Procurement manager 108 performs the purchase order generation dynamically without user input upon receiving the schedule from procurement calculation engine 106. Once procurement manager 108 automatically generates the purchase orders, procurement manager 108 may automatically send the purchase orders to a supplier of each of the respective raw materials, or procurement manager 108 may send the purchase orders to a user for approval before sending the purchase orders to respective suppliers.

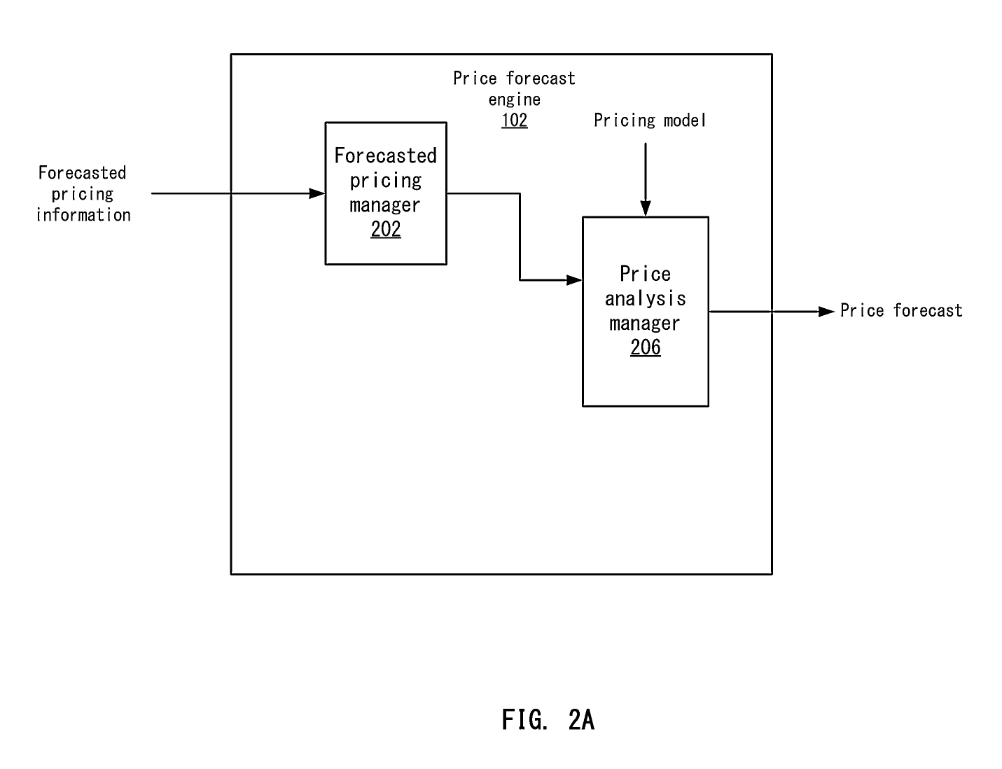

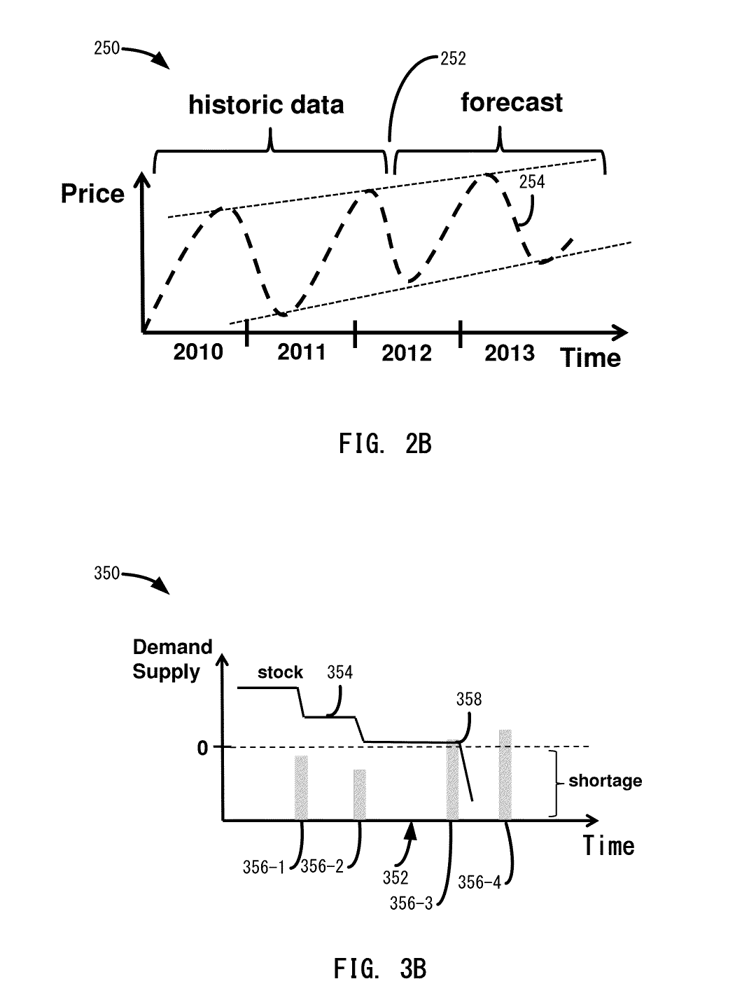

FIG. 2A depicts a more detailed example of price forecast engine 102 according to one embodiment. As mentioned above, price forecast engine 102 may be an external service or tool outside of an enterprise resource planning (ERP) system and thus different implementations may be appreciated. A forecasted pricing manager 202 receives forecasted pricing information. The forecasted pricing information may be derived from different sources. For example, the current price of raw materials may be received from external sources outside of the company, such as an external pricing web service. In one example, the forecasted pricing information may be the price at which the company may purchase the raw material on the current day. Additionally, the forecasted pricing information may also include predicted future pricing information, such as raw material prices may be predicted in the future. This forecasted pricing information may be continuously received and updated.

A price analysis manager 206 receives the forecasted pricing information and outputs a price forecast. Price analysis manager 206 may receive a pricing model that price forecast manager 206 applies to the forecasted pricing information to determine the price forecast. The pricing model may balance the forecasted pricing information while taking into consideration other factors, such as general resource shortages and long-term political factors. The price forecast may forecast the price of a raw material for a certain time in the future. The ability to forecast the price may be based on the assumption that predictable periodic prices may occur during the period of time. It will be recognized that certain factors may affect the price that may be unpredictable, such as political events may occur that may alter the price rapidly.

FIG. 2B shows a graph 250 of an example of a price forecast output by price analysis manager 206 as received by the price forecasting tool in form of price/time relationship according to one embodiment. Graph 250 maps the price versus time. A point 252 indicates the current time. Thus, points before point 252 include the historical data and points after point 252 include forecasted data. As can be seen in a price forecast at 254, the price fluctuates over time. Price analysis manager 206 predicts how the price may fluctuate based on historic market prices, or a web service that provides historical data and the forecasted pricing information.

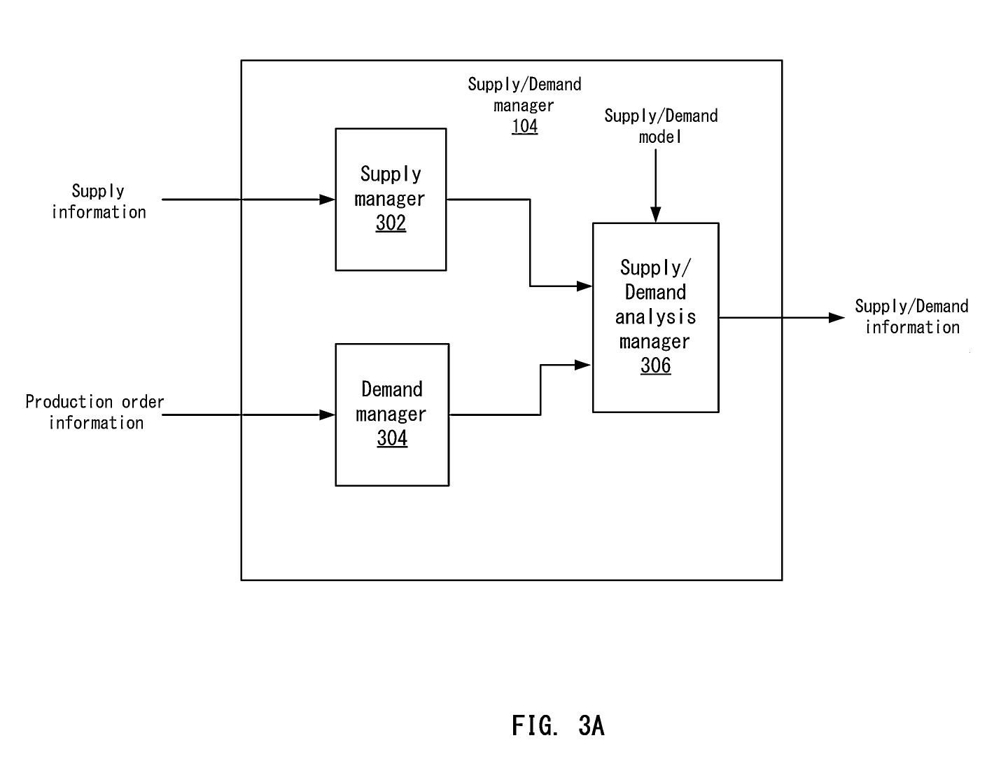

FIG. 3A depicts a more detailed example of supply/demand manager 104 according to one embodiment. Although this example of supply/demand manager 104 is described, other implementations and aspects in the supply/demand calculation may be taken into account. A supply manager 302 receives supply information, such as current stock information for a raw material. The current stock information may list the amount of raw material that is in stock for the company. For example, the ERP system may aggregate stock information for all raw materials that are stored throughout the company. Also, open purchase orders, purchase requests, etc. may be considered. Supply manager 302 may then forward the stock information to a supply/demand analysis manager 306.

A demand manager 304 receives production order information regarding the raw materials. The production order information indicates orders that have been received for the raw material from various entities. Also, production orders, reservations and sales might be considered. For example, a factory of the company may need raw material to manufacture a product. The factory would then submit a production order through the ERP system. The company may have various factories that each submits production orders that demand manager 304 aggregates. Additionally, demand manager 304 may predict the future demand by analyzing when production orders may be received at a future date.

Supply/demand analysis manager 306 receives the supply information and production order information from supply manager 302 and demand manager 304, respectively, and may use a supply/demand model to predict future supply/demand for the raw material. For example, future production use may be analyzed to determine the future supply/demand of the raw material for the company.

FIG. 3B depicts a graph 350 showing an example of supply/demand information according to one embodiment. Graph 350 maps the supply/demand versus time. A point 352 shows the current time. Thus, the time before point 352 shows actual supply/demand and the time after point 352 shows forecasted supply/demand. The stock of a raw material is shown at 354. Also, various production orders are shown at 356-1-356-4.

Production orders 356-1 and 356-2 are actual production orders and production orders 356-3 and 356-4 are predicted production orders. The quantity of each production order 356 is indicated by the height of the bar. After each production order 356, the stock of the raw material is decreased. For example, after production order 356-1, the stock of the raw material then decreases by a certain amount. Unless a purchase order for the raw material is produced, the stock continues to be depleted. At some point, if the stock is not replenished, a shortage may occur. For example, at 358, production order 356-3 causes a shortage as the supply of the raw material goes to 0. It is desirable that the company order more supplies of the raw material before this occurs and particular embodiments analyze the situation and generate purchase orders before shortages occur.

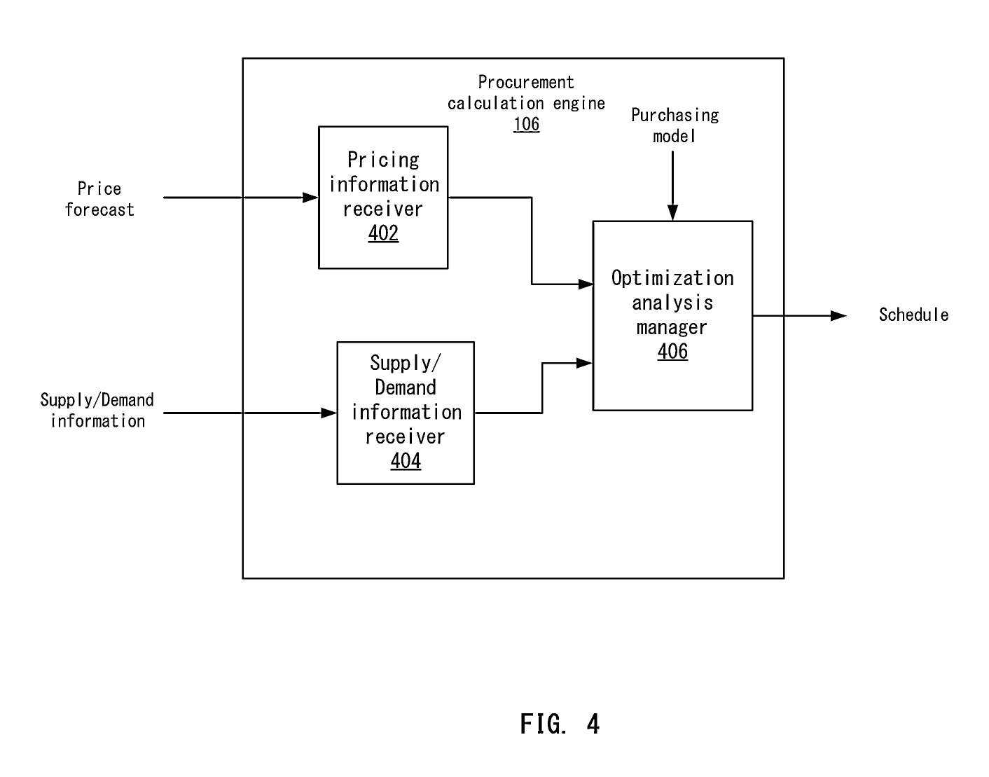

FIG. 4 depicts a more detailed example of procurement optimization engine 106 according to one embodiment. A pricing information receiver 402 receives the price forecast from price forecast engine 102. For example, pricing information receiver 402 may interact with price forecast engine 102 to receive the price forecast via a web service automatically (e.g. once each day) or manually via a file export and import. Also, a supply/demand information receiver 404 receives the supply/demand information from supply/demand information manager 104. Supply/demand information receiver 404 may be integrated with the company's ERP system to automatically receive (or manually request) the supply/demand information. Pricing information receiver 402 and supply/demand information receiver 404 may receive pricing information and supply/demand information for multiple raw materials and organize the information by raw material. An optimization analysis manager 406 receives the pricing information and the supply/demand information and is configured to output a schedule for purchasing each raw material on certain dates with certain quantities.

Optimization analysis manager 406 may use a purchasing model implementing a cost optimization strategy to determine the schedule.

The purchasing model may consider purchasing costs, warehouse costs, and financial costs. Purchasing costs may be the material price (e.g., per volume) and/or the fixed cost per procurement process. The material price is the price at which the raw material would have to be purchased and the fixed cost per procurement process is the cost of procuring the raw material.

The warehouse costs include storage costs and fixed costs for the logistics to receive the raw materials and also transfer the raw materials. The storage costs may be time dependent in that the longer the raw materials are stored, the greater the costs. The fixed costs for the logistics may be the costs incurred for receiving the materials and storing the materials in storage, and also the costs for transferring the materials from storage to production.

The financial costs may include the liquidity decrease and capital commitments/lock-up. The liquidity decrease may be the decrease in the amount of money that is available or the cost of additional credits due to the purchasing of the raw material. The capital commitment/lock-up may be the allocation of capital to the purchase thus meaning that the capital is no longer available to the company for other uses.

In one embodiment, the total cost accounting for the above aspects may be summarized as follows:

Total cost=purchasing costs+warehouse costs+financial costs=material price+procurement process costs+storage costs/storage duration+logistic process costs+financial costs.

It will be understood that optimization analysis manager 406 may not use all of the aspects of the total cost.

Optimization analysis manager 406 inputs the pricing forecast along with the supply/demand information into the purchasing model to determine a purchasing strategy for the raw material. For example, optimization analysis manager 406 attempts to purchase the raw material before the stock of the raw material falls below a certain level, but at optimal prices, such as when the price is around a low. Optimization analysis manager 406 may trigger a point in time, which may be the current time or a time in the future, when the company should order the raw material. Also, depending on the total cost calculated above and supply/demand, optimization analysis manager 406 determines a quantity to order or refers to a minimal order quantity.

To calculate the optimal point in time for purchasing raw materials, optimization analysis manager 406 overlays price/time relationships by time-related aspects of the procurement and logistic processes. The time-related aspects include a purchasing-related replenishment lead time, a warehouse-related goods processing time, and a production-related setup time. The purchasing-related replenishment lead time takes into account how long a purchase order is processed by either the company or the supplier until the material is delivered. For example, the company may have an approval process that takes 5 days and/or the supplier may have a process that approves the order within 3 days. The warehouse-related goods processing time is the amount of time in which the raw material takes to be stored in storage and/or the amount of time the raw material takes to be retrieved from storage. The production-related setup time is the amount of time needed to prepare the raw material for use in the production process. For example, once receiving the raw material at a factory, the factory may take a day to set up the equipment to use the raw material.

In one embodiment, optimization analysis manager 406 determines a procurement window based on the time-related aspects of the procurement and logistic processes and the supply/demand information. For example, based on the purchasing-related replenishment lead time, the warehouse-related processing time, and the production-related setup time, optimization analysis manager 406 determines a procurement window that starts at a current time and lasts until an end time, which may be the latest point in time in which a procurement order can be placed to have the material available, such as for the production process, when required, or before the material supply falls short or violates a given threshold. The end time may be the time in which the stock of the raw material would become a shortfall based on current supply/demand information shortened by the duration required to replace the stock. In one embodiment, optimization analysis manager 406 calculates the procurement window as follows:

Procurement window=current time; time (stock shortage)−replenishment lead time−goods processing time−production−related setup time.

Within the procurement window, optimization analysis manager 406 evaluates the price over time based on the pricing forecast and purchasing model.

Optimization analysis manager 406 detects the relative price minimum within the procurement window. The price minimum may be used to determine the optimal point in time for the placement of a purchase order. Optimization analysis manager 406 may determine the relative price minimum by comparing the price forecast in a point-by-point manner. For example, optimization analysis manager 406 may use the following method to determine the relative price minimum:

FOR(i=1, i<n, i=i+1)do(MIN(P(tᵢ), P(tᵢ+1)),

where i is a variable determining each point in the imported price/time relationship, MIN is a minimum function, P is the price, and t is time. In the above, the method checks consecutive points in time within the procurement window to determine the minimum price in the procurement window. Also, if needed, optimization analysis manager 406 may select multiple points to generate orders within the window. Based on the continued pricing forecast and supply/demand information, optimization analysis manager 406 may revise the schedule dynamically. Further, the process may continue to be repeated by moving the procurement window to different times.

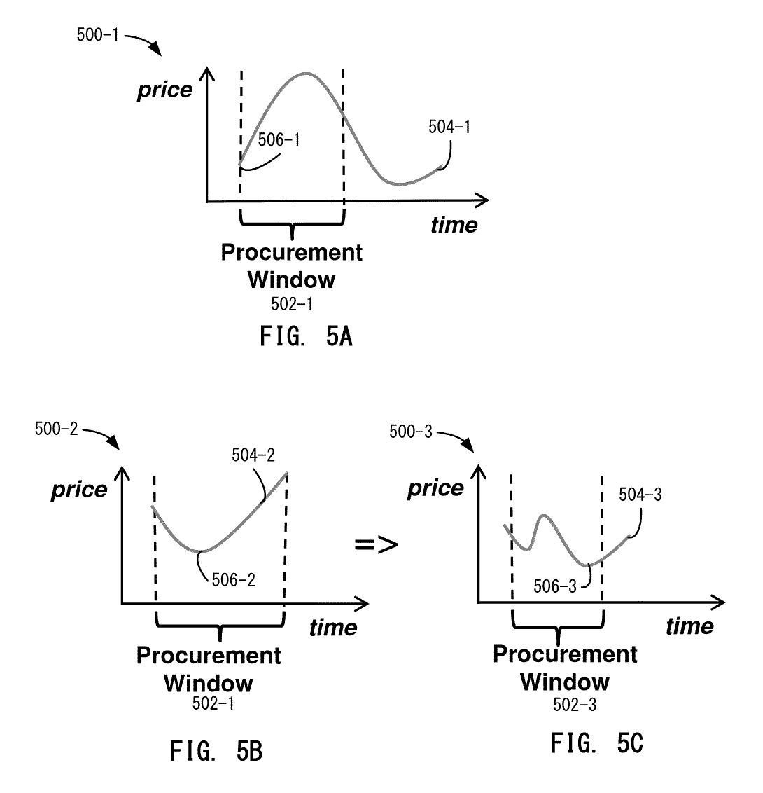

The method for determining when to place a purchase order will now be described in more detail. FIGS. 5A-5C show examples of purchase order decisions according to one embodiment. In FIG. 5A, a graph 500-1 shows the price vs. time for the raw material that is determined based on the price forecast. At 502-1, a procurement window is shown, and at 504-1, the price over time is illustrated.

Optimization analysis manager 406 analyzes the price forecast within the procurement window to determine when to place an order. In this case, optimization analysis manager 406 determines the optimal point is at a point 506-1. This coincides with the current time in the procurement window. In this case, optimization analysis manager 406 triggers a purchase order immediately. Optimization analysis manager 406 determines the optimal point is the current time because within the procurement window, the price does not go lower than the current price. The optimal point in time is the time of the relative price low minus (replenishment lead time+goods processing time+production-related setup time). So, not only the procurement window is shortened by replenishment lead time, goods processing time and production-related setup time, but also the ordering time is influenced by the same. The optimal point in time may be when the purchase order or purchase request needs to be triggered.

In other cases, optimization analysis manager 406 may determine that a purchase order should be delayed to a later point in time. FIG. 5B shows a graph 500-2 where the purchase order is triggered at a later time according to one embodiment. A second price forecast is shown at 504-2 in addition to a second procurement window at 502-2. As seen from the price forecast at 504-2, the price at the current time is not the lowest. Thus, optimization analysis manager 406 delays the generation of the purchase order to a later point in time. As time proceeds, this reduces available time in to order the raw material in the procurement window. However, the price forecast may be refined over the shorter procurement window that may allow optimization analysis manager 406 to make a more informed purchase order decision. FIG. 5C shows a revised procurement window 502-3 that is shorter in duration than the procurement window 502-2. Additionally, an updated price forecast at 504-3 is shown. As can be seen, the accuracy of the price forecast may be greater than the accuracy shown in the price forecast at 504-2 due to the shorter time period. Optimization analysis manager 406 then determines that a time 506-2 should be the point in which a purchase order should be generated.

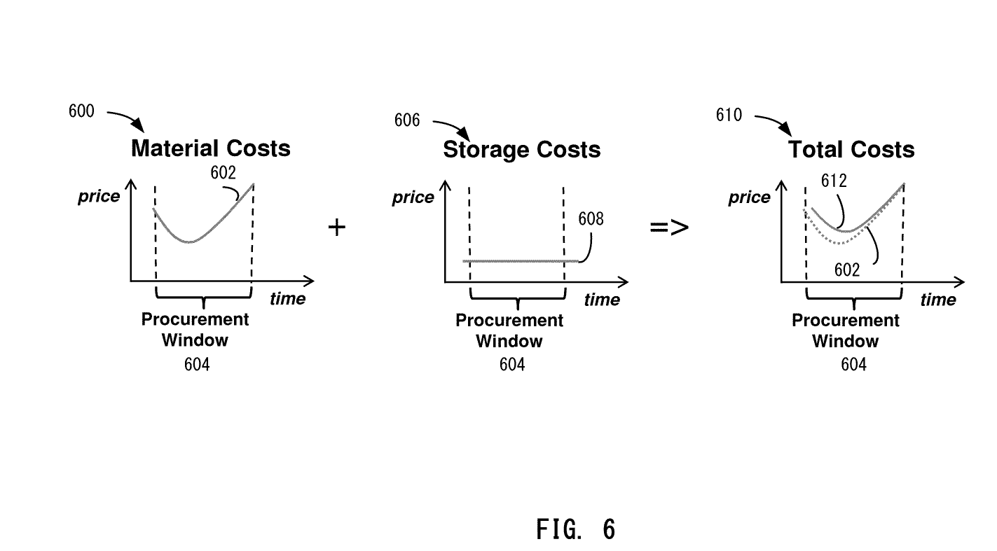

Optimization analysis manager 406 may also take into account the storage costs and financial costs when determining the optimal point in time to generate a purchase order. FIG. 6 depicts an example for adjusting the price forecast based on the storage costs according to one embodiment. Financial costs are not shown, but also could be used. A graph 600 shows the material costs based on the price forecast. A price forecast over time is shown at 602 within a procurement window 604. A graph 606 shows the storage costs over the procurement window shown at 604. For example, the costs over time are shown at 608. A graph 610 shows the total cost when taking into account the material costs and storage costs. As shown, the original price forecast for the material cost is shown at 602. Optimization analysis manager 406 adjusts the price forecast as shown at 612 to reflect the storage costs.

The storage costs are linearly time dependent. That is, the storage costs from the time receiving the raw material until its consumption are added to the raw material price at each point in time in procurement window 604. As the time between receiving and consumption of the material decreases when the material is purchased at a later point in time, the additional cost factor because of the additional storage costs decreases as well until the end of the procurement window when the storage costs become zero. As can be seen at the adjusted price forecast shown at 612, the adjusted price forecast equals the prior forecast shown at 602 at the end of procurement window 604. However, at points before the end, the adjusted price forecast at 612 is higher than the original price forecast shown at 602. Also, if financial costs were used, they would also adjust the price forecast in the linearly time dependent manner similar to the storage costs.

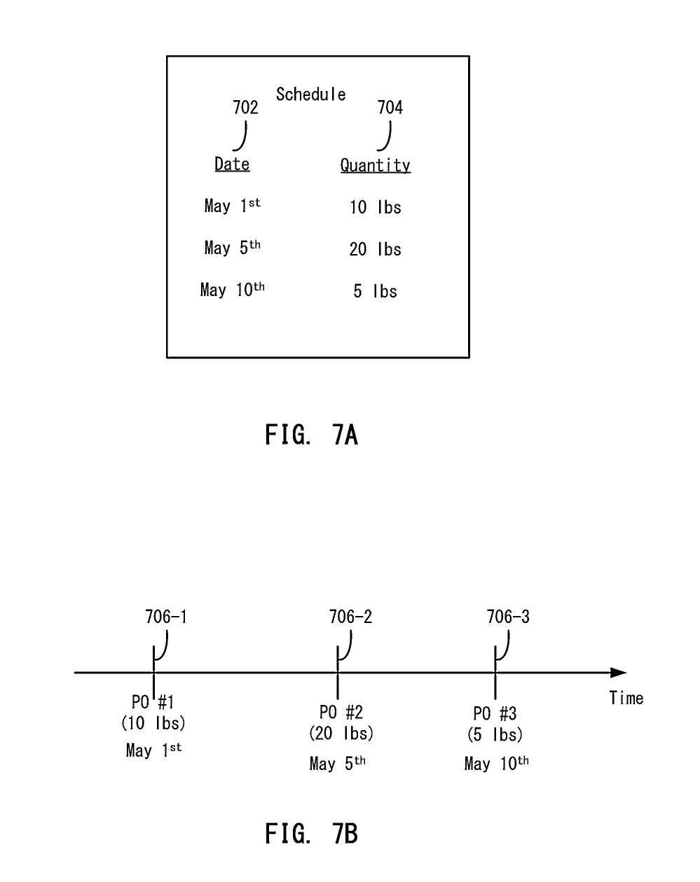

FIG. 7A depicts an example of a schedule according to one embodiment. Optimization analysis manager 406 may output a schedule for multiple dates to purchase the raw material. For example, at 702, the schedule includes multiple dates in which a purchase should be made. Also, at 704, a quantity of the raw material to purchase is listed at each date. By predicting in the future the amount to purchase, a company may then make sure that purchase orders are submitted such that the raw material may be purchased on the exact date on the schedule. For example, FIG. 7B shows a timeline that shows when procurement manager 108 generates purchase orders according to one embodiment. For example, on May 1^{st}, procurement manager 108 generates a purchase order 706-1 for 10 pounds of the raw material. These dates already reflect the factors influencing the procurement window. Also, procurement manager 108 generates a purchase order 706-2 on May 5^{th} for 20 pounds, and on May 10^{th}, procurement manager 108 generates a purchase order 706-3 for 5 pounds.

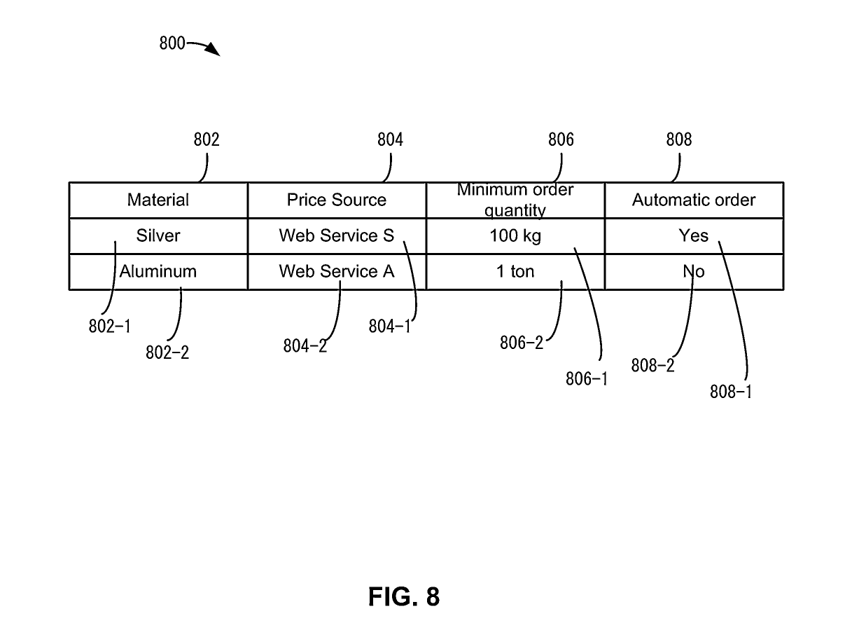

The procurement process may also be customized by a user. FIG. 8 depicts an example of a table that summarizes data that can be customized by a user of the company for procurement optimization engine 106 according to one embodiment. At 802, a column lists the raw material. For example, at 802-1, data for the raw material silver is provided, and at 802-2, data for the raw material aluminum is provided. At 804, a column for the price source is provided. For example, the user may select the source of the pricing information, such as web services may be used. In this case, at 804-1, silver uses the price source of web service S, and at 804-2, aluminum uses the price source of web service A.

At 806, a user may define a minimum order quantity. For example, at 806-1, silver has a 100 kg minimum order quantity, and at 806-2, aluminum has a 1 ton minimum order quantity. The minimum order quantity will be considered if procurement optimization engine 106 calculates quantities less than the minimum order quantity. For example, procurement optimization engine 106 may adjust the order quantity to the minimum order quantity if the quantity calculated is below the minimum order quantity.

At 808, a user can define whether an automatic order for the raw material should be generated and sent to a supplier. At 808-1, purchase orders for silver are automatically generated, and at 808-2, purchase orders for aluminum are not automatically generated. This means that procurement manager 108 automatically generates a purchase order for silver and sends the purchase order to a supplier without approval from a user. However, for aluminum, procurement manager 108 generates a purchase order, but this purchase order needs to be approved by a user before being sent to a supplier.

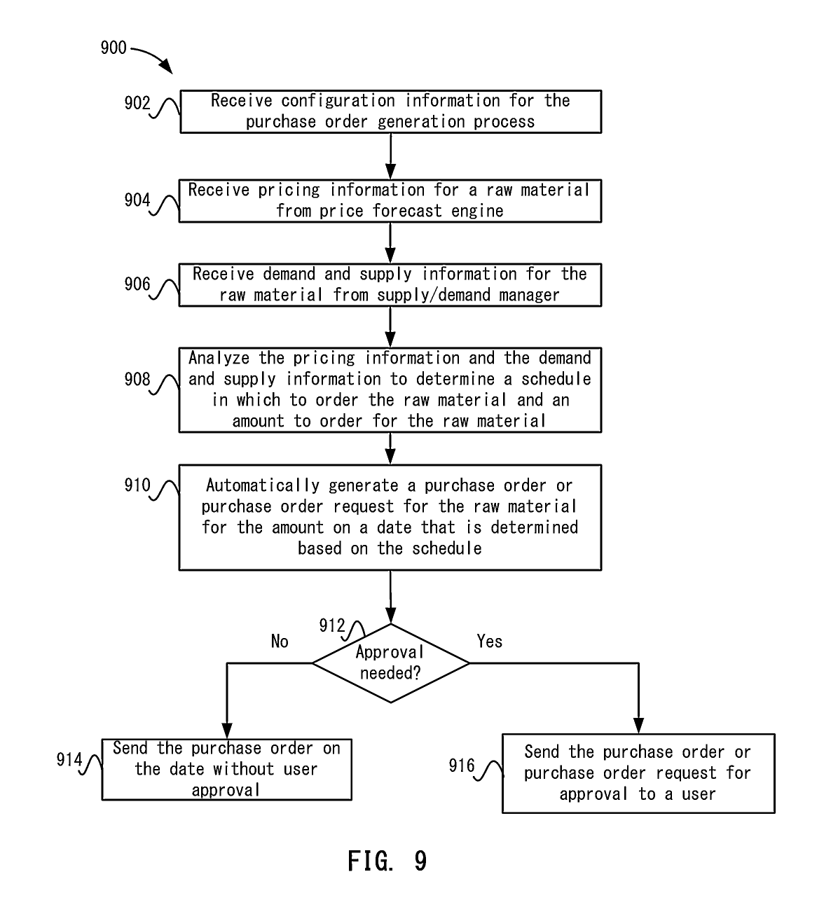

FIG. 9 depicts a simplified flowchart 900 of a method for generating purchase orders according to one embodiment. At 902, procurement optimization engine 106 receives configuration information for the purchase order generation process. For example, the configuration described in FIG. 8 may be received.

At 904, procurement calculation engine 106 receives pricing information for a raw material from price forecast engine 102. Also, at 906, procurement calculation engine 106 receives demand and supply information for the raw material from supply/demand manager 104.

At 908, procurement calculation engine 106 analyzes the pricing information and the demand and supply information to determine a schedule in which to order the raw material and an amount to order for the raw material. The calculation described above may be used. At 910, procurement calculation engine 106 automatically generates a purchase order or purchase order request for the raw material for the amount on a date that is determined based on the schedule. As discussed above, the purchase order or purchase order request may need approval. At 912, procurement manager 108 determines if approval is needed. At 914, if approval is not needed, procurement manager 108 may generate the purchase order on the date without user approval. At 916, if approval is needed, procurement manager 108 sends the purchase order or purchase order request for approval to a user. After approval is received, procurement manager 108 generates and sends the purchase order to the supplier.

Particular embodiments provide many advantages. For example, system 100 closes a gap between purchasing for raw material procurement. Best price procurement of raw materials is of interest to manufacturing companies considering the global shortages combined with price fluctuations caused by seasonal demand and speculation. System 100 attempts to procure high-value raw materials at advantageous prices. System 100 makes procurement decisions based on price evaluations that are triggered based on a purchasing model evaluating relative price minimums in an interval of time given by procurement and production constraints. This provides reliable long-term planning instead of a pure demand-driven procurement. This type of planning also will avoid emergency purchases during price levels that may impact the profits or margins for a product being manufactured. System 100 may be integrated directly into purchasing software such that purchase orders may be automatically generated. However, different levels of authorization may be programmed into system 100.

Particular embodiments integrate demand planning with best price procurement of raw materials in an ERP system. Thus, companies can consider global shortages of raw materials combined with price fluctuations caused by seasonal demand and speculation. Particular embodiments procure raw materials at advantageous prices based on price evaluation and the current and future supply/demand situation and also trigger purchase orders at relative price minimums providing reliable long-term planning instead of using a pure demand-driven procurement. This type of planning avoids emergency purchases during price bubbles that may impact profits.

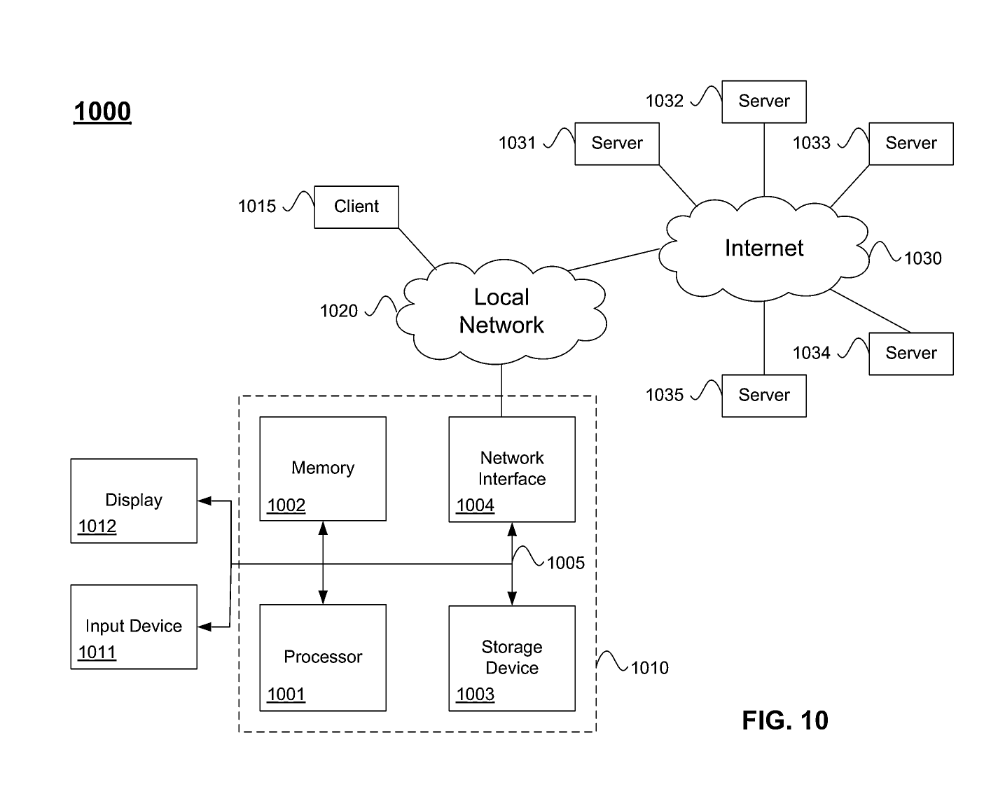

FIG. 10 illustrates hardware of a special purpose computing machine configured with procurement calculation engine 106 according to one embodiment. An example computer system 1010 is illustrated in FIG. 10. Computer system 1010 includes a bus 1005 or other communication mechanism for communicating information, and a processor 1001 coupled with bus 1005 for processing information. Computer system 1010 also includes a memory 1002 coupled to bus 1005 for storing information and instructions to be executed by processor 1001, including information and instructions for performing the techniques described above, for example. This memory may also be used for storing variables or other intermediate information during execution of instructions to be executed by processor 1001. Possible implementations of this memory may be, but are not limited to, random access memory (RAM), read only memory (ROM), or both. A storage device 1003 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1003 may include source code, binary code, or software files for performing the techniques above, for example. Storage device and memory are both examples of computer readable storage mediums.

Computer system 1010 may be coupled via bus 1005 to a display 1012, such as a cathode ray tube (CRT) or liquid crystal display (LCD), for displaying information to a computer user. An input device 1011 such as a keyboard and/or mouse is coupled to bus 1005 for communicating information and command selections from the user to processor 1001. The combination of these components allows the user to communicate with the system. In some systems, bus 1005 may be divided into multiple specialized buses.

Computer system 1010 also includes a network interface 1004 coupled with bus 1005. Network interface 1004 may provide two-way data communication between computer system 1010 and the local network 1020. The network interface 1004 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1004 sends and receives electrical, electromagnetic, or optical signals that carry digital data streams representing various types of information.

Computer system 1010 can send and receive information through the network interface 1004 across a local network 1020, an Intranet, or the Internet 1030. In the Internet example, software components or services may reside on multiple different computer systems 1010 or servers 1031-1035 across the network. The processes described above may be implemented on one or more servers, for example. A server 1031 may transmit actions or messages from one component, through Internet 1030, local network 1020, and network interface 1004 to a component on computer system 1010. The software components and processes described above may be implemented on any computer system and send and/or receive information across a network, for example.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
determining, by a computing device, pricing information for a raw material used in industrial production of a product for a company, the pricing information including forecasted pricing information for the raw material;
determining, by the computing device, demand and supply information describing a supply of the raw material for the company and a demand for the raw material of how much of the raw material the company plans to use;
analyzing, by the computing device, the forecasted pricing information and the supply of the raw material and the demand for the raw material to determine a point in time in which to order the raw material and an amount of the raw material to order at the point in time;
automatically, by the computing device, generating information for a purchase order for the raw material for the point in time in the amount; and
outputting, by the computing device, the information for the purchase order.

2. The method of claim 1, wherein outputting comprises automatically generating a purchase order from the information for the purchase order and sending the purchase order to a supplier of the raw material.

3. The method of claim 2, wherein the purchase order is sent to the supplier without approval from a user for the purchase order.

4. The method of claim 1, wherein outputting comprises:
sending a notification for the information for the purchase order to a user;
receiving approval to send the purchase order from the user; and
generating a purchase order from the information for the purchase order and sending the purchase order to a supplier of the raw material upon receiving the approval.

5. The method of claim 1, further comprising generating a plurality of points in time to order the raw material, wherein generating the information for the purchase order comprises:
automatically generating information for a plurality of purchase orders at the plurality of points in time.

6. The method of claim 1, wherein analyzing comprises:
determining a procurement window in which to order the raw material based on the demand and supply information, the procurement window including a start time and an end time;
determining a price forecast within the procurement window based on the pricing information; and
selecting the point in time in the procurement window to order the raw material based on a purchasing model and the price forecast.

7. The method of claim 6, further comprising:
delaying the selecting the point in time until a time later than the start time;
refining the price forecast in a smaller procurement window at a new start time to the end time; and
selecting the point in time in the smaller procurement window to order the raw material based on the purchasing model and the price forecast.

8. The method of claim 6, further comprising:
determining price dependent costs associated with the raw material; and
adjusting the price forecast based on the price dependent costs in a time dependent manner.

9. The method of claim 6, further comprising:
receiving storage costs or financial costs for the raw material during the procurement window;
adjusting the price forecast based on the storage costs or financial costs in the procurement window in a linear time-dependent manner; and
selecting the point in time in the procurement window to order the raw material based on the purchasing model and the adjusted price forecast.

10. The method of claim 6, wherein determining the procurement window comprises:
determining based on the supply and demand information a latest point in time in which a purchase order can be generated to have the raw material supplied to the company without the supply of the raw material falling below a threshold.

11. The method of claim 1, wherein analyzing comprises:
determining purchasing costs for purchasing the raw material based on the pricing information;
determining warehouse costs related to storing the raw material;
determining financial costs to the company due to the purchase of the raw material; and
optimizing the purchasing costs, warehouse costs, and the financial costs to determine the point in time.

12. The method of claim 11, wherein the purchasing costs include a material price of the raw material based on the pricing information or a fixed cost for procuring the raw material.

13. The method of claim 11, wherein the warehouse costs include a storage cost to store the raw material or a fixed cost for receiving the raw material for storage.

14. The method of claim 11, wherein the financial costs include a liquidity decrease due to a purchase of the raw material or a capital commitment cost due the purchase of the raw material.

15. The method of claim 1, wherein the raw material is a high value raw material, wherein the raw material is high value when the risk of supply disruption is above a threshold.

16. A non-transitory computer-readable storage medium containing instructions, that when executed, control a computer system to be configured for:
determining pricing information for a raw material used in industrial production of a product for a company, the pricing information including forecasted pricing information for the raw material;
determining demand and supply information describing a supply of the raw material for the company and a demand for the raw material of how much of the raw material the company plans to use;
analyzing the forecasted pricing information and the supply of the raw material and the demand for the raw material to determine a point in time in which to order the raw material and an amount of the raw material to order at the point in time;
automatically generating information for a purchase order for the raw material for the point in time in the amount; and
outputting the information for the purchase order.

17. The non-transitory computer-readable storage medium of claim 16, wherein analyzing comprises:
determining a procurement window in which to order the raw material based on the demand and supply information, the procurement window including a start time and an end time;
determining a price forecast within the procurement window based on the pricing information; and
selecting the point in time in the procurement window to order the raw material based on a purchasing model and the price forecast.

18. The non-transitory computer-readable storage medium of claim 18, further comprising:
determining price dependent costs associated with the raw material; and
adjusting the price forecast based on the price dependent costs in a time dependent manner.

19. The non-transitory computer-readable storage medium of claim 16, wherein analyzing comprises:
determining purchasing costs for purchasing the raw material based on the pricing information;
determining warehouse costs related to storing the raw material;
determining financial costs to the company due to the purchase of the raw material; and
optimizing the purchasing costs, warehouse costs, and the financial costs to determine the point in time.

20. An apparatus comprising:
one or more computer processors; and
a non-transitory computer-readable storage medium comprising instructions, that when executed, control the one or more computer processors to be configured for:
determining pricing information for a raw material used in industrial production of a product for a company, the pricing information including forecasted pricing information for the raw material;
determining demand and supply information describing a supply of the raw material for the company and a demand for the raw material of how much of the raw material the company plans to use;
analyzing the forecasted pricing information and the supply of the raw material and the demand for the raw material to determine a point in time in which to order the raw material and an amount of the raw material to order at the point in time;
automatically generating information for a purchase order for the raw material for the point in time in the amount; and
outputting the information for the purchase order.
